(19) United States
(12) Patent Application Publication
(10) Pub. No.: US 2012/0040318 A1
(43) Pub. Date: Feb. 16, 2012

(54) Clinical forensic video template: trauma, for mediation and facilitation in personal injury and medical malpractice law

(76) Inventor: Michelle Lisa Shafer, South Lyon, MI (US)

(21) Appl. No.: 12/806,345

(22) Filed: Aug. 11, 2010

(51) Int. Cl. G09B 23/28

(52) U.S. Cl. 434/262

(57) ABSTRACT

A medico-legal template process, created by the Medical—Nursing community, that audio-visually demonstrates actual injury and trauma of a patient physically, functionally, mentally, emotionally and psychologically, and it's impact on altering that patient's pre-morbid/baseline activities of daily living, and relationships, both short and long term. The audio-visual record is a patient focused, neutral, medical and nursing assessment and analysis application for the discovery, mediation and litigation components of personal injury and medical malpractice law, and other applicable fields of study. This material is unique and original in that it applies the Nursing Process to the Clinical Forensic Video, it is created by the Medical-Nursing community for the Legal community, and it creates a neutral position within Plaintiff and Defense litigation.

### CROSS-REFERENCES

U.S. Pat. No. 7,582,064. Sep. 1, 2009. System and method for foot assessment. Inventors: Martindale; Michael Shorten; Martyn. System and method for foot assessment. A method for assessing displacement of the talus relative to an axis of the foot and lower leg, which includes marking the anatomy of a test subject to enable tracking of the movement of the talus relative to the axis, and aligning the foot in a first position, and observing the displacement of the talus as indicated by the marking relative to the first position while allowing a displacement of the rear foot bone complex. Another embodiment includes a system for assessing pronation in a foot.

U.S. Pat. No. 7,440,594. Oct. 21, 2008. Inventors: Takenaka; Hideki. Face identification device and face identification method. Face identification device and face identification method. The present invention is to protect the right of portrait or privacy of people other than a specific person, and to enable easy recognition of information other than the face of the specific person and the situation around the specific person. Images videotaped by the surveillance cameras are captured in the computer, face images are detected therefrom, and the detected face images are compared with the face image of a specific person registered in the storage device. As the results of the comparison, when these face images do not match with each other, a mosaic process is applied exclusively to the detected face images to protect the privacy of the people other than the specific person, whereas the mosaic process is not applied to the parts other than the faces, such as dress and baggage, thereby keeping them as they are. When these face images match with each other, the face image of the specific person is not applied with the mosaic process, thereby keeping his or her face and remaining parts as they are.

U.S. Pat. No. 7,801,440. Sep. 21, 2010. Inventors: Mowry; Craig. System and method for digital film simulation. The invention includes a system for imparting at least one characteristic of photographic emulsion to an image. The system includes a light transmissible medium at least partially provided with photographic film emulsion, wherein the photographic film emulsion is capable of being exposed and chemically processed. Furthermore, light that is related to an image is projected through a selected portion of the photographic film emulsion. Moreover, a containment is included for providing the light transmissible medium in a position relative to the projected light, wherein the image is imparted with the at least one quality related to the photographic film emulsion.

U.S. Pat. No. 7,716,232. May 11, 2010. Inventors: Glenn; Christopher J. Devices, systems and methods for producing and distributing multiple variations of an instance of a media presentation. Devices, systems, and methods are described for authoring, producing, securing, and/or distributing multiple variations of an instance of a media presentation. For example, one device embodiment includes a processor and memory having instructions executable on the processor. The instructions can allow a producer of media content to define a number of variating dimensions for a media presentation, maintain subscriber variation database tables having records that define subscriber variations in terms of a set of variating dimensions from the number of variating dimensions, maintain media element database tables having records that define media elements in terms of a set of variating dimensions from the number of variating dimensions, and determine which elements and in what order the elements are to be included a variation of an instance of a media presentation.

U.S. Pat. No. 7,502,641. Mar. 10, 2009. Inventors: Breen; Alan. Method for imaging the relative motion of skeletal segments. Methods and apparatus for measuring the movement of bones during joint motion in a subject using a motion table, an imaging device, and software program for tracking, calculating and graphing the results of the motion study. The apparatus is a motion table used to control the movement of the subject while an imaging device captures images during that movement. The images are analyzed using a computer software program that tracks the individual bones that make up the joint, calculates their relative movements, and graphically displays the results as a function of time.

U.S. Pat. No. 7,257,832. Aug. 14, 2007. Inventors: Beane; John A., Heminger; Larry J., Stone; Robert M. Medical image capture system and method. As patient video images are captured in a lab, they are converted into an uncompressed data set and stored locally on a hospital site server, where they are immediately viewable by diagnosticians in the hospital. The hospital site server generates a plurality of compressed data sets for use by the Internet Data Center. Additionally, the uncompressed data set and a plurality of compressed data sets are stored permanently on a centralized Internet Data Center, from which they can be searched out and displayed by any client device running web-browser software. A client is provided with immediate access to the uncompressed images when pausing and requesting the images of interest from the server. The patient video images are automatically delivered to any authorized Clinical Research Organizations, they are delivered back to the treating hospital when the patient returns for subsequent visits, and are viewable through in-hospital viewing stations over a private high-speed network.

### DESCRIPTION

Background: There is a desperate need for improvement of the process for identification, compilation and presentation of actual clinical injury of a patient, particularly within the discovery process in personal injury and medical malpractice law mediation and litigation, and the need for an invention for the foregoing reasons:

There is a need for an unbiased, factual and neutral clinical presentation of patient injury.
There is a need to precisely compile and present an unbiased account of actual patient injury, and the short and long term effects of injury on the patient, in a time and cost effective audio-visual documentation format.

Brief Summary: The present invention is directed to the legal community, and all other applicable uses, that meet these needs. The procedural method comprises, but is not limited to, an audio-visual demonstration and clinical discussion of actual patient injury, with both the patient and actual treating clinicians, and pertinent parties, with short and long term impact and effects of the injury, for a neutral, unbiased identification of actual medical injury that is comprised of a medico-legal template process, created by the Medical—Nursing community, having at least the following elements set forth below. These and other features, aspects, and advantages of the present invention will become better understood with reference to the following description and claims.

Specifications/Process Description: A medico-legal template process, created by the Medical—Nursing community, that audio-visually demonstrates actual injury and trauma of a patient physically, mentally, emotionally and psychologically, and it's impact on altering that patient's pre-morbid/baseline activities of daily living, both short and long term. This application is considered part of a patient's medical and legal record.

Consideration must be given to maintaining the patient's dignity and privacy during the making of the audio-visual, and the handling of all information shall be in compliance with HIPA regulation. The clinical forensic objective is a patient focused, neutral, medical and nursing assessment and analysis application for the discovery, mediation and litigation components of personal injury and medical malpractice law, and other applicable fields of study.

The process is: A clinical identification of alteration(s) in human body system integrity by trauma and injury as evidenced by clinical deficits in: Neurological, Cardiovascular, Integumentary, Gastrointestinal, Musculoskeletal, Renal, Genito-Urinary, Psychiatric Emotion, Cognition and Learning, Psychosocial/Relationships, Activities of Daily Living, as evidenced by:

Implementing objective measurable criteria: Historical Identification Contrast: Pre and Post Morbidity: Lifestyle and relationships, Photography, Video, Medical Records, Education Records, Employment Records, Driving Records, Community Involvement. Force of gravity and torque assessment: Directional flow of force of gravity through the human body. Pounds per square inch of torque impact on the human body. Assessment of motor vehicle and other object damages. Photography. Film footage/video records. Police Reports and records. Computer generated accident reconstruction. Pertinent Medical Records: Emergency Medical Service documentation. Emergency Department and Clinic Documentation. Intra-operative surgical documentation. Clinical assessments, diagnoses and treatment plans. Therapy assessment and documentation Radiodiagnostics and Tests: Magnetic resonance imaging. CATscan. Bone scan. X-ray film. Serum laboratory values. Electroencephalogram. Echocardiogram. Somato-Sensory Evoked Potentials. Muscle Evoked Potentials. Electromyelogram. Neuropsychological testing. Functional capacity testing. All other pertinent clinical diagnostics. Wound and Scar Assessment: Dimensions and severity. Healing time. Impact on body image. Hardware, Implant and Prosthesis Assessment: Causation. Lifetime of implanted device, rate of failure. Mobility Assessment: Bed roll. Lie to Sit. Sit at edge of bed. Sit to Stand. Transfers: Bed to chair, Chair to bed. Toilet transfers: Wheelchair to toilet, Toilet to wheelchair. Wheelchair to tub bench. Tub bench to wheelchair. Wheelchair to car. Car to wheelchair. Ambulation. Stair climbing. Wheelchair mobility, curbs, van lift. Hygiene: Face washing. Teeth brushing. Handwashing. Shaving: face, arms, legs. Make up application. Hair combing, brushing, styling. Hair washing. Bathing. Fingernail and toenail clipping and filing. Toileting: bladder and bowel function. Dressing: Upper body; bra, undershirt, shirt/blouse, sweater, coat, hat, gloves. Lower body; underwear, pants socks/pantyhose, shoes, boots. Use of assistive devices, i.e. reachers. Independent Activities of Daily Living: Cooking and meal preparation. Cleaning. Laundry. Shopping. Bill Pay and Financial Management. Driving. Working. Community Involvement. Advanced Activities of Daily Living: Problem-solving, Prioritization, Organization Judgment. Reasoning, logical thought content. Memory.

And implementing subjective measurable criteria: Psychiatric and Psychosocial: Thought processes. Mood. Attitude. Motivation. Sleep. Appetite. Sexuality. Impact on relationship; consortium, communication, change in role. Pain Assessment: Location. Type. Frequency. Intensity. Duration.

In an Audio-visual documentation. Videotaping; Shall take place in the clinical setting, in the patient's dwelling or in the community. Shall not exceed 2 hours at a time for patient comfort. Shall be factual and actual audio-visual documentation of the patient, injury and sequelae, and all pertinent parties involved. End product shall not exceed twenty-five (25) minutes duration. Fee Schedule is a fixed rate. Audio-visual formatting and editing techniques shall include, but are not limited to: Continuity Editing. Insert shots: injured body parts, hardware, medical procedures. Cutaways. Highlighting of medical and police document segments and radiodiagnostics. Relational editing. Parallel editing. Chapters. Voice-Overs: explanatory/teaching format. Subtitles.

Thereby developing and creating an audio-visual clinical forensic template specific to the patient: I. Introduction; Incident description. Photographs. Film footage. Police Report. Emergency Medical Service and/or Medflight documentation. Emergency Department documentation. Analysis of impact: gravitational force, torque. Patient pre and post morbidity status. Photographs. Film footage. II. Clinical forensics; Interviews (see interview choices below*). Medical Documents—highlighted. Diagnostic Radiographics—with pointer arrows, subtitles. Photographs—with pointer arrows, subtitles. III. Conclusion; Synopsis/recapitulation of trauma injury, impact of injuries on activities of daily living, short and long term effects. Patient statement when possible, to the question: “How does if feel to be you?”, Photograph/Video.

Videotape interviews of a patient, his/her clinicians and pertinent parties may include, but are not limited to: Physician/Surgeon: Videotaping of clinical discussion of actual injury with use of radiographics, medical illustration or devices in an instructional/teaching format. Patient and Physician: Videotaping of actual patient assessment by the clinician. Patient and Nurse: Videotaping of actual patient assessment by the clinician. Videotaping of actual hands-on care of the injury or sequelae of the injury, i.e. colostomy care and stoma, tracheostomy care, orthopaedic pin care, wound care, etc. Patient and Therapist: Videotaping of actual patient assessment by the clinician. Videotaping of patient performance in therapy, i.e. range of motion, transfers, ambulation, stair climbing. Patient and Caregiver: Videotaping of caregiver assistance to the patient with; actual hands-on care of the injury or sequelae of the injury, i.e. colostomy care and stoma, tracheostomy care, orthopaedic pin care, wound care, etc. activities of daily living: mobility and transfers, hygiene, grooming, dressing, cooking, cleaning, laundry, bill pay and financial management, driving, transportation decision-making, problem-solving, memory loss and confusion impacting activities of daily living. Patient and Spouse/Significant Other: Videotaping of demonstration of communication ability between the couple, and significant change or alteration in relationship roles due to injury. Patient with Children and, or Family: Videotaping of patient with children and family in the home at mealtime, demonstrating change in roles, mobility and meal preparation and participation.

Advantage. The use and advantage of this specified process is to fulfill a desperate need for improvement of the factual compilation and presentation of actual clinical injury of a patient, particularly within the discovery process in personal injury and medical malpractice law mediation and litigation, and the need for an invention for the foregoing reasons: There is a need for an unbiased, factual and neutral clinical presentation of patient injury to precisely compile and present an unbiased account of actual patient injury, and the short and long term effects of injury on the patient, in a time and cost effective audio-visual documentation format. Although the present invention has been described in considerable detail with references to certain preferred versions thereof, other versions are possible. Therefore, the spirit and scope of the appended claims should not be limited to the description of the preferred versions contained therein.

What is claimed is:

1. Audio-visually demonstrates actual injury and trauma of a patient.

2. Includes injuries that are physical, functional, mental, emotional and psychological to the patient.

3. Demonstrates the impact of injury on altering that patient's pre-morbid/baseline, functional capacity and activities of daily living, vocational and avocational abilities and it's impact on the patient's relationships.

4. Demonstrates the impact of injury of the patient, both short and long term.

5. Is considered part of a patient's medical and legal record.

6. Is patient focused and clinically neutral

7. Is a Medical and Nursing assessment and analysis application

8. Made by licensed, credential actual treating clinicians with a traditional clinician-patient relationship with the patient.

9. Applies the Clinical Nursing Process.

10. May be applied in, and, or, for the discovery, mediation and litigation components of personal injury and medical malpractice law.

11. Creates a neutral position within Plaintiff and Defense litigation.

12. May be used in other applicable fields of study.
